(19) United States
(12) Patent Application Publication
(10) Pub. No.: US 2023/0416153 A1
(43) Pub. Date: Dec. 28, 2023

(54) Low Density Gypsum Panel

(71) Applicant: Gold Bond Building Products, LLC, Charlotte, NC (US)

(72) Inventors: R. G. Iyer, Charlotte, NC (US); Terry Moser, Matthews, NC (US); Bradley J. Busche, Shelby, NC (US); Eli Stav, Charlotte, NC (US); Michael N. Blades, Indian Land, SC (US); Joseph J. Bailey, Charlotte, NC (US); Craig Robertson, Charlotte, NC (US); Daisha Holloman, Charlotte, NC (US)

(21) Appl. No.: 18/319,530

(22) Filed: May 18, 2023

Related U.S. Application Data
(60) Provisional application No. 63/343,609, filed on May 19, 2022.

(51) Int. Cl. C04B 28/14; C04B 14/22; C04B 24/38; C04B 38/10; B32B 13/02; B32B 13/08; B32B 13/14; B32B 5/02; B32B 7/02; B32B 37/24

(52) U.S. Cl. CPC C04B 28/14; C04B 14/22; C04B 24/38; C04B 38/10; B32B 13/02; C04B 2111/00629; B32B 13/14; B32B 5/022; B32B 7/02; B32B 37/24; B32B 13/08

(57) ABSTRACT

The present invention is directed to a gypsum panel and a method of making a gypsum panel. The gypsum panel comprises a gypsum core and a facing material. The gypsum core includes gypsum, a foaming agent, and optionally starch in an amount of less than 4 wt. % based on the weight of gypsum. The gypsum core includes air voids having an average void size of 50 microns or more. The gypsum panel has a density of 33 pcf or less, a weight of 1,800 lbs/MSF or less, and an NRC value of 0.2 or more.

### CROSS-REFERENCE TO RELATED APPLICATION

The present application claims filing benefit of U.S. Provisional Patent Application No. 63/343,609 having a filing date of May 19, 2022, which is hereby incorporated by reference in its entirety.

### BACKGROUND

A building is typically constructed with walls having a frame comprising vertically oriented studs connected by horizontally oriented top and bottom plates or tracks. The walls often include one or more gypsum panels fastened to the studs and/or plates on each side of the frame or, particularly for exterior walls, one or more gypsum panels fastened to the studs and/or plates on one side of the frame with a non-gypsum-based sheathing attached to an exterior side of the frame. A ceiling of the building may also include one or more gypsum panels oriented horizontally and fastened to joists, studs, or other structural members extending horizontally in the building. These gypsum panels typically include a gypsum core and facing materials on the major surfaces. With the amount of gypsum panels required for a building, it is generally preferred to have a relatively lightweight panel having a relatively low density that satisfies certain performance characteristics, such as acoustical properties, mechanical properties, etc.

As a result, there is a need to further improve gypsum panels. In particular, to provide gypsum panels having a generally light weight and/or a generally low density while also exhibiting certain mechanical and performance properties.

### SUMMARY OF THE INVENTION

In accordance with one embodiment of the present invention, a gypsum panel is disclosed. The gypsum panel comprises a gypsum core and a facing material. The gypsum core includes gypsum, a foaming agent, and optionally starch in an amount of less than 4 wt. % based on the weight of gypsum. The gypsum core includes air voids having an average void size of 50 microns or more. The gypsum panel has a density of 33 pcf or less, a weight of 1,800 lbs/MSF or less, and an NRC value of 0.2 or more.

In accordance with another embodiment of the present invention, a method of making a gypsum panel is disclosed. The method comprises: providing a first facing material, providing a gypsum slurry comprising stucco, a foaming agent, optionally starch in an amount of less than 4 wt. % based on the weight of stucco, and water onto the first facing material, providing a second facing material onto the gypsum slurry, and allowing the stucco to set. The gypsum panel has a density of 33 pcf or less, a weight of 1,800 lbs/MSF or less, and an NRC value of 0.2 or more.

In accordance with one embodiment of the present invention, a gypsum panel is disclosed. The gypsum panel comprises a gypsum core and a facing material. The gypsum core includes gypsum, a foaming agent, and optionally starch in an amount of less than 4 wt. % based on the weight of gypsum. The gypsum panel has a density of 33 pcf or less, a weight of 1,800 lbs/MSF or less, and an NRC value of 0.2 or more.

### BRIEF DESCRIPTION OF THE DRAWINGS

The invention will now be described, by way of example, with reference to the accompanying drawings, in which:

FIG. 1 illustrates the NRC values of the panels tested in Example 1; and

FIGS. 2 and 3 illustrate voids having a double porosity/interconnected pore structure.

### DETAILED DESCRIPTION

Reference will now be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel includes a gypsum core formed from a gypsum slurry. The gypsum core includes gypsum (i.e., calcium sulfate dihydrate) and may include other optional additives. The present inventors have discovered that the gypsum panel disclosed herein can be relatively lightweight and/or have a relatively low density while still exhibiting the desired mechanical and/or performance properties. For instance, the gypsum panel may exhibit desired mechanical properties, acoustical properties, and/or handling properties, etc.

In addition, to provide such a gypsum panel, the gypsum core may have a particular void structure. For instance, core voids having an average diameter of less than 300 microns may be 30% or less, such as 25% or less, such as 20% or less, such as 15% or less, such as 10% or less of the total core voids. In this regard, core voids having an average diameter of less than 300 microns may be or more, such as 0.1% or more, such as 0.2% or more, such as 0.5% or more, such as 1% or more, such as 2% or more, such as 3% or more, such as 5% or more. In one embodiment, such core voids may reference any air voids due to voids generated from the use of a soap/foam.

Similarly, core voids having an average diameter of less than 150 microns may be 30% or less, such as 25% or less, such as 20% or less, such as 15% or less, such as 10% or less, such as 5% or less of the total core voids. In this regard, core voids having an average diameter of less than 150 microns may be 0.01% or more, such as 0.1% or more, such as 0.2% or more, such as 0.5% or more, such as 1% or more, such as 2% or more, such as 3% or more, such as 5% or more, such as 8% or more. In one embodiment, such core voids may reference any air voids due to voids generated from the use of a soap/foam.

Further, core voids having an average diameter of less than 100 microns may be 30% or less, such as 25% or less, such as 20% or less, such as 15% or less, such as 10% or less, such as 5% or less of the total core voids. In this regard, core voids having an average diameter of less than 100 microns may be or more, such as 0.1% or more, such as 0.2% or more, such as 0.5% or more, such as 1% or more, such as 2% or more, such as 3% or more, such as 5% or more, such as 8% or more. In one embodiment, such core voids may reference any air voids due to voids generated from the use of a soap/foam.

In addition, core voids having an average diameter of less than 50 microns may be 30% or less, such as 25% or less, such as 20% or less, such as 15% or less, such as 10% or less, such as 5% or less of the total core voids. In this regard, core voids having an average diameter of less than 50 microns may be or more, such as 0.1% or more, such as 0.2% or more, such as 0.5% or more, such as 1% or more, such as 2% or more, such as 3% or more, such as 5% or more, such as 8% or more. In one embodiment, such core voids may reference any air voids due to voids generated from the use of a soap/foam.

In addition, the average core void size may be 50 microns or more, such as 75 microns or more, such as 100 microns or more, such as 125 microns or more, such as 150 microns or more, such as 200 microns or more, such as 250 microns or more, such as 275 microns or more, such as 300 microns or more, such as 325 microns or more, such as 350 microns or more, such as 375 microns or more, such as 400 microns or more, such as 500 microns or more, such as 600 microns or more, such as 700 microns or more, such as 800 microns or more, such as 900 microns or more, such as 1,000 microns or more. The average core void size may be 1,500 microns or less, such as 1,300 microns or less, such as 1,100 microns or less, such as 1,000 microns or less, such as 900 microns or less, such as 800 microns or less, such as 700 microns or less, such as 600 microns or less, such as 550 microns or less, such as 500 microns or less, such as 450 microns or less, such as 400 microns or less, such as 375 microns or less, such as 350 microns or less, such as 325 microns or less, such as 300 microns or less, such as 275 microns or less, such as 250 microns or less, such as 225 microns or less, such as 200 microns or less, such as 175 micron or less, such as 150 microns or less, such as 125 microns or less, such as 100 microns or less. In one embodiment, such core voids may reference any air voids due to voids generated from the use of a soap/foam. Furthermore, while the aforementioned references an average core void size, it should be understood that in another embodiment, such size may also refer to a median core void size.

The void sizes may be determined using means in the art. For instance, a scanning electron microscope may be utilized wherein cross-sections are analyzed at a 50× magnification at random locations of a board with one each close to the face of the panel, one in the center of the panel, and one close to the back of the panel. The voids are measured in an area of approximately 4 mm 2 and the average and median sizes are based on measuring all voids having a size of microns or greater in diameter. During the review, edge circumferences are drawn on the voids and measured to calculate the void size and area.

Furthermore, the core voids may have an open geometry (i.e., open-cell), a closed geometry (i.e., closed-cell), or a mixture thereof. In one embodiment, the core voids may be closed-cell or have a closed geometry. In another embodiment, the core voids may be open-cell or have an open-geometry. In general, with an open geometry, the voids may be interconnected. This is contrary to closed-cell, which do not include interconnections. Accordingly, in certain embodiments, at least 0.01%, such as at least 1%, such as at least 5%, such as at least 10%, such as at least 20%, such as at least 30%, such as at least 40%, such as at least 50%, such as at least 60%, such as at least 70%, such as at least 80%, such as at least 90% of the voids may be open-celled voids or have an open geometry. In addition, in certain embodiments, 100% or less, such as 95% or less, such as 90% or less, such as 85% or less, such as 80% or less, such as 75% or less, such as 60% or less, such as 50% or less, such as 40% or less, such as 30% or less of the voids may be open-celled voids or have an open geometry.

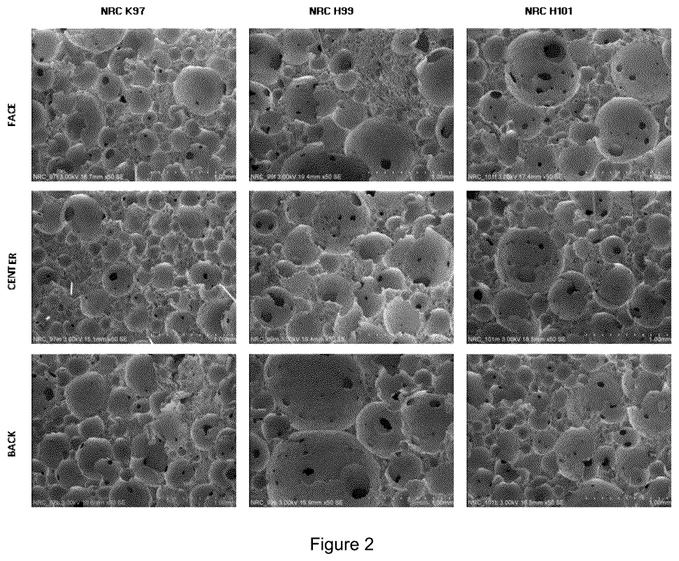

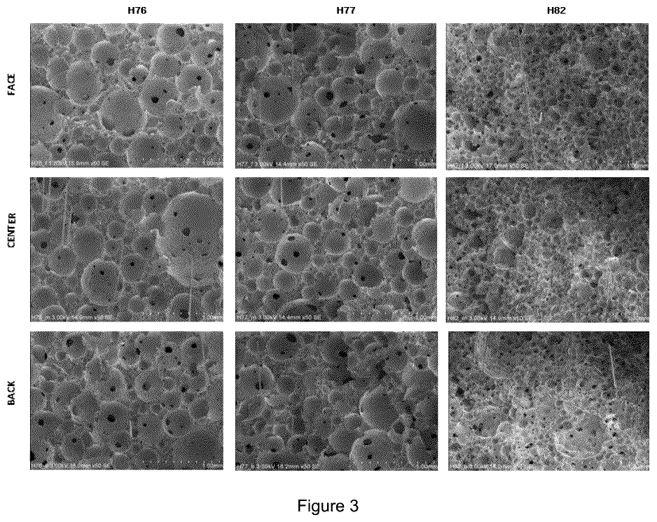

In one embodiment, the core voids, such as the air voids, may have a double porosity or interconnected pore structure. That is, such voids may be interconnected with at least one or two other voids. For instance, FIGS. 2 and 3 illustrate voids having such a structure. In such figures, a plurality of voids include multiple darkened areas indicating interconnections with one or more than one void thereby forming a double porosity/interconnected structure.

In this regard, at least 5%, such as at least 10%, such as at least 15%, such as at least 20%, such as at least 25%, such as at least 30, such as at least 40%, such as at least 50%, such as at least 60%, such as at least 70%, such as at least 80%, such as at least 90%, such as at least 95% of the voids may have such double porosity/interconnected structure whereby they are interconnected with at least two other voids. In this regard, 100% or less, such as 99% or less, such as 95% or less, such as 90% or less, such as 85% or less, such as 80% or less, such as 75% or less, such as 70% or less, such as 60% or less, such as 50% or less, such as 40% or less, such as 30% or less, such as 25% or less, such as 20% or less, such as 10% or less of the voids may have such double porosity/interconnected structure.

In addition, the present inventors have managed to control the coalescence of the voids in order to obtain the desired core void structure. Without intending to be limited, the present inventors have managed to avoid creating a shear plane at the interface of the gypsum core and the facing material. As a result, voids can be present not only within the gypsum core but even at the surfaces of the gypsum core. Without intending to be limited, such control can inhibit or minimize the degree of formation of a densified layer at the interface which may impede performance of the panel. Accordingly, without intending to be limited, the voids may be relatively uniformly distributed throughout the gypsum core.

Because of the light weight and/or low density, one may expect the panels to not exhibit desired acoustical properties. However, to the contrary, the present inventors have discovered that the gypsum panel as disclosed herein exhibits improved acoustical properties compared to other conventional panels. For instance, the noise reduction coefficient (“NRC”) is generally a measure of the sound absorption property of a material or panel, such as a gypsum panel. Generally, an NRC value may range from 0 to 1.00. As an example, an NRC value of 0.70 means that approximately 70% of the sound is absorbed by a panel, while approximately 30% is reflected back into the environment. In this regard, gypsum panels made according to the present invention may have higher NRC values than other types of gypsum panels and in certain instances even higher NRC values than certain mineral fiber panels, indicating improved sound absorbance and acoustical properties. For instance, the NRC value of the gypsum panel disclosed herein may be 0.20 or more, such as 0.21 or more, such as 0.23 or more, such as 0.25 or more, such as 0.27 or more, such as 0.29 or more, such as 0.30 or more, such as 0.31 or more, such as 0.32 or more, such as 0.33 or more, such as 0.34 or more, such as 0.35 or more, such as 0.36 or more, such as or more, such as 0.38 or more, such as 0.39 or more, such as 0.40 or more, such as 0.41 or more, such as 0.42 or more, such as 0.43 or more, such as 0.44 or more, such as 0.45 or more, such as 0.46 or more, such as 0.47 or more, such as or more, such as 0.49 or more, such as 0.50 or more. The NRC value of the gypsum panel may be 1.00 or less, such as 0.90 or less, such as 0.80 or less, such as 0.70 or less, such as 0.60 or less, such as 0.55 or less, such as 0.53 or less, such as 0.50 or less, such as 0.48 or less, such as 0.46 or less, such as 0.45 or less, such as 0.43 or less, 0.41 or less, such as 0.40 or less. In one embodiment, the aforementioned NRC values are based on ASTM C423, herein incorporated by reference in its entirety. In another embodiment, the aforementioned NRC values are based on ASTM E1050, herein incorporated by reference in its entirety. For example, such latter test may be employed for small-scale testing.

As indicated herein, the present invention discloses a gypsum panel. The gypsum panel includes a gypsum core having a gypsum layer surface. In particular, the gypsum layer surface includes a first gypsum layer surface and a second gypsum layer surface opposing the first gypsum layer surface. A facing material is provided on the gypsum layer surface. For instance, a first facing material is provided on the first gypsum layer surface and a second facing material is provided on the second gypsum layer surface. In this regard, the first facing material and the second facing material sandwich the gypsum core.

In general, the composition of the gypsum core is not necessarily limited and may include any additives as known in the art. For instance, the additives may include dispersants, foam or foaming agents including aqueous foam (e.g. sulfates), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present invention.

In one particular embodiment, the gypsum core and/or gypsum slurry may include an accelerator. For instance, the accelerator may include land plaster, a metallic salt, or a mixture thereof. For instance, the metallic salt may be one that can provide anions, such as a sulfate. In particular, the metallic salt may be aluminum sulfate, ammonium sulfate, potassium sulfate, calcium sulfate, iron sulfate, iron chloride, or etc. or a mixture thereof. The metallic salt may be one that provides cations, such as alkaline earth metal ions, such as calcium ions. The accelerator may also be a gypsum-based accelerator such as one typically referred to as a ball milled accelerator. The accelerator may be combined with a grinding aid. For instance, the grinding aid may include a sugar, such as dextrose, sucrose, etc. The grinding may include boric acid, sand, or others known in the art as well as any combination of the aforementioned. When utilized with a grinding aid, the weight ratio of the grinding aid to the land plaster may be 0.01 or more, such as 0.05 or more, such as 0.1 or more, such as 0.2 or more, such as 0.3 or more, such as 0.4 or more, such as 0.5 or more, such as 0.6 or more, such as 0.7 or more, such as 0.8 or more. The weight ratio may be less than 1, such as 0.9 or less, such as 0.8 or less, such as 0.7 or less, such as 0.6 or less, such as 0.5 or less, such as 0.4 or less, such as 0.3 or less, such as 0.2 or less, such as 0.15 or less, such as 0.1 or less.

In one particular embodiment, the gypsum core may include fillers and/or fibers. These fillers and/or fibers may include natural and/or synthetic fillers and/or fibers. For example, these may include glass fibers, cellulose fibers, paper fibers, or a mixture thereof. In one embodiment, the fibers may include glass fibers, cellulose fibers, or a mixture thereof. In another embodiment, the fibers may include glass fibers. In a further embodiment, the fibers may include cellulose fibers. In an even further embodiment, the fibers may include glass fibers and cellulose fibers.

In addition, the gypsum core may include a sound dampening polymer. For example, the polymer may have a relatively low glass transition temperature. For instance, the polymer may have a glass transition temperature of room temperature or less. For instance, the polymer may have a glass transition temperature of 200° C. or less, such as 180° C. or less, such as 150° C. or less, such as 130° C. or less, such as 100° C. or less, such as 80° C. or less, such as 60° C. or less, such as 50° C. or less, such as 40° C. or less, such as 30° C. or less, such as 25° C. or less, such as 20° C. or less, such as 10° C. or less, such as 5° C. or less, such as 1° C. or less, such as 0° C. or less, such as −5° C. or less, such as −10° C. or less, such as −15° C. or less, such as −20° C. or less, such as −25° C. or less, such as −30° C. or less, such as −35° C. or less, such as −40° C. or less, such as −50° C. or less. The polymer may have a glass transition temperature of −90° C. or more, such as −80° C. or more, such as −75° C. or more, such as −70° C. or more, such as −65° C. or more, such as −60° C. or more, such as −55° C. or more, such as −50° C. or more, such as −40° C. or more, such as −30° C. or more, such as −20° C. or more, such as −10° C. or more, such as 0° C. or more, such as 10° C. or more, such as 20° C. or more, such as 30° C. or more, such as 50° C. or more, such as 80° C. or more, such as 100° C. or more.

The sound dampening polymer may include, as non-limiting examples, synthetic resins, polymers and copolymers, and latex polymers as are known in the art. For instance, the sound dampening polymer may be an acrylic-based polymer, a silicone-based polymer, a rubber-based polymer, or a mixture thereof. In one embodiment, the sound dampening polymer may be an acrylic-based polymer. In another embodiment, the sound dampening polymer may be a silicone-based polymer. In a further embodiment, the sound dampening polymer may be a rubber-based polymer. In a preferred embodiment, the sound dampening polymer is an acrylic (or acrylate) polymer or copolymer.

In one embodiment, the gypsum core may optionally include a starch in an amount of less than 4 wt. % based on the weight of gypsum in the gypsum core. For instance, the gypsum core may include a starch in an amount of about 0 wt. % based on the weight of gypsum in the gypsum core. Alternatively, the gypsum core may include a starch in an amount of less than 4 wt. %, such as 3.8 wt. % or less, such as 3.5 wt. % or less, such as 3.3 wt. % or less, such as 3 wt. % or less, such as 2.8 wt. % or less, such as 2.5 wt. % or less, such as 2.3 wt. % or less, such as 2 wt. % or less, such as 1.8 wt. % or less, such as 1.5 wt. % or less, such as 1.3 wt. % or less, such as 1 wt. % or less, such as 0.8 wt. % or less, such as 0.6 wt. % or less, such as 0.5 wt. % or less based on the weight of gypsum in the gypsum core. The starch may be present in an amount of greater than 0 wt. %, such as 0.1 wt. % or more, such as 0.2 wt. % or more, such as 0.5 wt. % or more, such as 0.7 wt. % or more, such as 0.9 wt. % or more, such as 1 wt. % or more, such as 1.2 wt. % or more, such as 1.4 wt. % or more, such as 1.6 wt. % or more, such as 1.8 wt. % or more, such as 2 wt. % or more, such as 2.2 wt. % or more, such as 2.4 wt. % or more, such as 2.6 wt. % or more, such as 2.8 wt. % or more based on the weight of gypsum in the gypsum core.

In one particular embodiment, the gypsum core may include a polyoxazoline. In this regard, a polyoxazoline as described herein may be provided in a gypsum slurry such that it may be present in the gypsum core. It should be understood that the gypsum core disclosed herein may comprise more than one polyoxazoline. For instance, the gypsum core disclosed herein may comprise two polyoxazolines or three polyoxazolines.

The polyoxazoline may have a repeating unit represented by the following formula:

—[N(R¹)—(C(H)(R²))ₘ]— (I)

wherein:
R¹ is R³—(C(H)(R⁴))ₙ—(C(O)N(H))ₚ—R⁵;
R² is selected from H and optionally substituted C₁₋₅ alkyl;
R³ is C(O), C(O)O, C(O)NH or C(S)NH;
R⁴ is selected from H and optionally substituted C₁₋₅ alkyl;
R⁵ is H; a C₁₋₅ alkyl; aryl; or a moiety comprising a functional group selected from an amine, an oxyamine, a thiol, a phosphine, an alkynyl, an alkenyl, an aryl, an aldehyde, a carbonyl, an acetal, an ester, a carboxyl, a carbonate, a chloroformate, a hydroxyl, an ether an azide, a vinyl sulfone, a maleimide, an isocyanate, isothiocyanate, an epoxide, orthopyridyl disulfide, sulfonate, halo acetamide, halo acetic acid, hydrazine, and anhydride;
m is 2 or 3;
n is 0-5; and
p is 0 or 1.

As indicated above, R² is selected from H and optionally substituted C₁₋₅ alkyl. In one embodiment, R² is an optionally substituted C₁₋₅ alkyl, such as methyl or ethyl. In one particular embodiment, R² is H.

As indicated above, R³ is C(O), C(O)O, C(O)NH or C(S)NH. In one embodiment, R³ is C(O), C(O)O, or C(O)NH. In another embodiment, R³ is C(O) or C(O)O. In one particular embodiment, R³ is C(O).

As indicated above, R⁴ is selected from H and optionally substituted C₁₋₅ alkyl. In one embodiment, R⁴ is an optionally substituted C₁₋₅ alkyl, such as methyl or ethyl. In one particular embodiment, R⁴ is H.

As indicated above, R⁵ is H; a C₁₋₅ alkyl; aryl; or a moiety comprising a functional group selected from an amine, an oxyamine, a thiol, a phosphine, an alkynyl, an alkenyl, an aryl, an aldehyde, a ketone, an acetal, an ester, a carboxyl, a carbonate, a chloroformate, a hydroxyl, an ether an azide, a vinyl sulfone, a maleimide, an isocyanate, isothiocyanate, an epoxide, orthopyridyl disulfide, sulfonate, halo acetamide, halo acetic acid, hydrazine, and anhydride. In one embodiment, R⁵ is H. In one particular embodiment, R⁵ is a C₁₋₅ alkyl, such as a methyl or ethyl. In a particular embodiment, R⁵ is ethyl.

As indicated above, m is 2 or 3. In one embodiment, m is 3. In one particular embodiment, m is 2.

As indicated above, n is 0-5. In one embodiment, n is 1-5. In one particular embodiment, n is 0.

As indicated above, p is 0 or 1. In one embodiment, p is 1. In one particular embodiment, p is 0.

In one embodiment, the repeating unit of formula (I) may have the following structure:

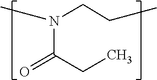

While the aforementioned structure is provided, it should be understood that other polyoxazoline having other structures may also be employed according to the present invention. For instance, such polyoxazolines may have additional or alternative substituent groups, for example as a result of additional or alternative substituent groups present in the pre-polymerized oxazoline compound.

According to one embodiment, the polyoxazoline may be a poly(2-oxazoline). In particular, the polyoxazoline may be a poly(2-substituted-2-oxazoline). For instance, the substitution may be an alkyl group. For instance, the alkyl group may be a C₁-C₁₀ alkyl group, such as a C₂-C₁₀ alkyl group, such as a C₂-C₉ alkyl group, such as a C₂-C₅ alkyl group. For instance, the alkyl group may be a methyl group, an ethyl group, a propyl group, a butyl group, a pentyl group, a hexyl group, a heptyl group, an octyl group, a nonyl group, a decyl group, etc. In this regard, the polyoxazoline may be a poly(2-alkyl-2-oxazoline). For instance, the polyoxazoline may be poly(2-methyl-2-oxazoline), poly(2-ethyl-2-oxazoline), poly(2-propyl-2-oxazoline), poly(2-butyl-2-oxazoline), poly(2-pentyl-2-oxazoline), poly(2-methyl-2-oxazoline), poly(2-hexyl-2-oxazoline), poly(2-heptyl-2-oxazoline), poly(2-octyl-2-oxazoline), poly(2-nonyl-2-oxazoline), poly(2-decyl-2-oxazoline), etc. In one particular embodiment, the polyoxazoline may be poly(2-ethyl-2-oxazoline).

The polyoxazoline may also be one having a terminal functional group. For instance, the functional group may be a hydroxyl group (e.g., a hydroxyalkyl group, such as a hydroxyethyl group, or a hydroxyalkylamine group, such as a hydroxyethylamine group), a thiol group, an alkynyl group, an alkenyl group, an amine group, etc. The polyoxazoline may be poly(2-ethyl-2-oxazoline) α-methyl, ω-2-hydroxyethylamine terminated, poly(2-ethyl-2-oxazoline) α-benzyl, ω-thiol terminated, poly(2-ethyl-2-oxazoline) alkyne terminated and poly(2-ethyl-2-oxazoline) amine terminated, and the like. In this regard, with such functional groups, the polyoxazoline may be a poly(2-ethyl-2-oxazoline) with a terminal functional group.

Generally, the polyoxazoline includes those polymers typically formed from oxazolines. The polyoxazoline can be formed by a ring-opening polymerization of an oxazoline, such as a 2-oxazoline, as generally known in the art. The ring-opening polymerization can generally be conducted in the presence of a cationic polymerization catalyst at a reaction temperature of about 0° C. to about 200° C. The catalyst may include, but is not limited, to strong mineral acids, organic sulfonic acids and their esters, acidic salts such as ammonium sulfate, Lewis acids such as aluminum trichloride, stannous tetrachloride, boron trifluoride and organic diazoniumfluoroborates, dialkyl sulfates and other like catalysts.

In addition to the above, it should be understood that the polyoxazoline may also be a copolymer. For instance, in addition to the oxazoline monomer, a second monomer as known in the art may also be polymerized with such oxazoline monomer to form a polyoxazoline that is a copolymer. Such second monomer may be another oxazoline monomer or another type of monomer.

While not necessarily limited, the polyoxazoline may have a weight average molecular weight of 1,000 g/mol or more, such as 5,000 g/mol or more, such as 10,000 g/mol or more, such as 25,000 g/mol or more, such as 35,000 g/mol or more, such as 40,000 g/mol or more, such as 45,000 g/mol or more, such as 50,000 g/mol or more. The polyoxazoline may have a molecular weight of 1,000,000 g/mol or less, such as 750,000 g/mol or less, such as 500,000 g/mol or less, such as 250,000 g/mol or less, such as 200,000 g/mol or less, such as 150,000 g/mol or less, such as 100,000 g/mol or less, such as 80,000 g/mol or less, such as 70,000 g/mol or less, such as 60,000 g/mol or less, such as 55,000 g/mol or less, such as 50,000 g/mol or less, such as 40,000 g/mol or less, such as g/mol or less, such as 20,000 g/mol or less, such as 10,000 g/mol or less. The molecular weight may be determined using means in the art, such as gel permeation chromatography.

Each additive may be present in the gypsum core in an amount of wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as wt. % or less, such as 0.4 wt. % or less, such as 0.35 wt. % or less, such as 0.2 wt. % or less. The aforementioned weight percentages may also apply based on the weight of the gypsum in the gypsum panel. In one embodiment, the aforementioned weight percentages may also apply based on the weight of the gypsum panel. Alternatively, the weight percentages may be based on the weight of the gypsum core. In a further embodiment, such weight percentages may be based on the solids content of the gypsum slurry.

The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The facing material is generally a non-woven type of facing material. For instance, these may include spunbound/spunlace, airlaid, drylaid, or wetlaid type facing materials. In one embodiment, the facing material may be a spunbound/spunlace type facing material. In another embodiment, the facing material may be an airlaid type facing material. In a further embodiment, the facing material may be a drylaid type facing material. In an even further embodiment, the facing material may be a wetlaid type facing material. In one embodiment, aforementioned types of facing materials may be for glass mat facing materials.

As indicated above, the facing material may be a polymeric facing material. In this regard, such polymeric facing material may be one based on synthetic polymers, natural polymers, or a mixture thereof. In one embodiment, such polymeric facing material may be based on synthetic polymers. Such synthetic polymers may for example include polyolefins, polyamides, polyesters, etc. In another embodiment, such polymeric facing material may be based on natural polymers. Such natural polymers may include cellulosic based polymers (e.g., cotton), wool, silk, etc. In a further embodiment, such polymeric facing material may be based on a combination of synthetic polymers and natural polymers.

As indicated above, the facing material may be a fibrous facing material. For instance, the fibrous facing material may be a glass mat facing material. The glass mat facing material may be made from one or more glass fibers. For instance, the glass mat facing material may be made from a combination of glass fibers having different lengths and/or diameters. In another embodiment, the fibrous facing material may be made from one or more organic, polymer fibers, or a mixture thereof. For instance, in one embodiment, these fibers may include polymer fibers. In another embodiment, these fibers may include organic fibers. For instance, the organic fibers may include natural fibers. The natural fibers may include cellulosic fibers, oat fibers, bast fibers (e.g., jute, flax, hemp, ramie, kenaf, etc.), leaf fibers (banana, sisal, agave, pineapple, etc.), seed fibers (coir, cotton, kapok, etc.), grass/reed fibers (e.g., wheat, corn, rice, etc.), and mixtures thereof. In one embodiment, the fibrous facing material may be made from one or more glass fibers as well as organic, polymer fibers, or a mixture thereof. The fibers may have an average diameter of 3 microns or more, such as 5 microns or more, such as 7 microns or more, such as 9 microns or more, such as 11 microns or more, such as 13 microns or more, such as 15 microns or more, such as 17 microns or more. The fibers may have an average diameter of 23 microns or less, such as 21 microns or less, such as 19 microns or less, such as 17 microns or less, such as 15 microns or less, such as 13 microns or less, such as 11 microns or less, such as 9 microns or less, such as 7 microns or less. That is, for a respective type of fibers utilized, such respective type may have the aforementioned average diameter. In another embodiment, the combination of all types of glass fibers may have the aforementioned average diameter. In an even further embodiment, the combination of all types of fibers may have the aforementioned average diameter.

Furthermore, the fibers, in particular glass fibers, may have a particular size distribution. For instance, at least 20%, such as at least 30%, such as at least 40%, such as at least 50%, such as at least 60%, such as at least 70%, such as at least 80% of the fibers may have an average size that falls within the aforementioned diameters.

The fibers may be held together using a binder. For instance, the binder may be a urea-formaldehyde binder, an acrylic binder, starch, or a mixture thereof. In one embodiment, the binder may be a urea-formaldehyde binder. In another embodiment, the binder may be an acrylic binder. In a further embodiment, the binder may be a starch binder.

The glass mat facing material in one embodiment may be coated. However, in one particular embodiment, the glass mat facing material may not have a coating, such as a coating that is applied to the surface of the mat. Instead, the glass mat facing material may be one generally referred to as an impregnated glass mat facing material.

In one embodiment, the facing material may also have a plurality of perforations. Generally, the shape of the perforations may not necessarily be limited. For instance, the perforations may generally have a shape that is a circle, oval, square, rectangle, triangle, diamond, or any combination thereof. In one embodiment, the perforations all have one type of shape. In another embodiment, the perforations include a combination of shapes. Nevertheless, it should be understood however that the perforations may also have an irregular shape.

In addition, it should be understood that the perforations may also have various sizes. For instance, in one embodiment, the perforations may all have substantially the same size. In this regard, the perforations may have a regular size distribution, such that the area of each perforation is substantially similar. In another embodiment, the perforations may include at least two or more sizes. In this regard, the perforations may have an irregular size distribution, such that the area of more than one perforation is different. For instance, one perforation may generally be of a larger size than another perforation. Nevertheless, when taking into account all of the perforations, the average maximum dimension of the perforations may be 0.1 mm or more, such as 0.2 mm or more, such as 0.5 mm or more, such as 0.7 mm or more, such as 0.9 mm or more, such as 1 mm or more, such as 1.25 mm or more, such as 1.5 mm or more, such as 2 mm or more, such as 2.5 mm or more, such as 3 mm or more, such as 4 mm or more, such as 5 mm or more, such as 6 mm or more, such as 7 mm or more, such as 8 mm or more, such as 9 mm or more, such as 10 mm or more. The average maximum dimension of the perforations may be 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less, such as 4 mm or less, such as 3 mm or less, such as 2 mm or less.

In addition, the perforations may be substantially uniformly spaced in one embodiment. For instance, the center-to-center distance between adjacent perforations may be substantially the same. However, in another embodiment, the perforations may not be substantially uniformly spaced. For instance, the perforations may be provided on the facing material in a non-uniform arrangement. For example, the perforations may be provided as a design.

Regardless, the average center-to-center distance of the perforations may be 0.1 mm or more, such as 0.2 mm or more, such as 0.5 mm or more, such as 0.7 mm or more, such as 0.9 mm or more, such as 1 mm or more, such as 1.25 mm or more, such as 1.5 mm or more, such as 2 mm or more, such as 2.5 mm or more, such as 3 mm or more, such as 4 mm or more, such as 5 mm or more, such as 6 mm or more, such as 7 mm or more, such as 8 mm or more, such as 9 mm or more, such as 10 mm or more, such as 15 mm or more, such as 20 mm or more, such as 25 mm or more. The average center-to-center distance of the perforations may be 50 mm or less, such as 40 mm or less, such as 30 mm or less, such as 25 mm or less, such as 20 mm or less, such as 18 mm or less, such as 15 mm or less, such as 14 mm or less, such as 13 mm or less, such as 12 mm or less, such as 11 mm or less, such as 10 mm or less, such as 9 mm or less, such as 8 mm or less, such as 7 mm or less, such as 6 mm or less, such as 5 mm or less. In one embodiment, the aforementioned may refer to an end-to-end distance between perforations rather than a center-to-center distance.

The perforations may cover 0.5% or more, such as 1% or more, such as 2% or more, such as 3% or more, such as 5% or more, such as 7% or more, such as 10% or more, such as 15% or more, such as 20% or more, such as 25% or more, such as 30% or more, such as 40% or more, such as 50% or more of the surface area of the facing material. The perforations may cover 70% or less, such as 60% or less, such as 50% or less, such as 40% or less, such as 30% or less, such as 25% or less, such as 20% or less, such as 15% or less, such as 10% or less, such as 9% or less, such as 8% or less, such as 6% or less of the surface area of the facing material.

The perforations may be formed using any method generally known in the art. For instance, the perforations may be formed by drilling, punching, or other known hole-making techniques. Furthermore, the perforations may be formed in the facing material prior to providing the facing material for forming the gypsum panel. For instance, the perforations may be formed prior to providing the facing material on a conveying system, regardless of whether the facing material is provided prior to deposition of the gypsum slurry or after deposition of the gypsum slurry. Alternatively, the facing material may be provided for forming the gypsum panel and the perforations may be formed thereafter.

The facing material may have a particular basis weight (e.g., in lb/csf wherein csf denotes 100 ft²). For instance, the basis weight may be 1.0 lb/csf or more, such as 1.1 lb/csf or more, such as 1.2 lb/csf or more, such as 1.3 lb/csf or more, such as 1.5 lb/csf or more, such as 1.8 lb/csf or more, such as 2 lb/csf or more, such as 2.2 lb/csf or more, such as 2.5 lb/csf or more, such as 2.8 lb/csf or more, such as 3 lb/csf or more. The basis weight may be 5 lb/csf or less, such as 4.8 lb/csf or less, such as 4.5 lb/csf or less, such as 4.2 lb/csf or less, such as 4 lb/csf or less, such as 3.7 lb/csf or less, such as 3.5 lb/csf or less, such as 3.3 lb/csf or less, such as 3 lb/csf or less, such as 2.8 lb/csf or less, such as 2.6 lb/csf or less, such as 2.4 lb/csf or less, such as 2.2 lb/csf or less, such as 2 lb/csf or less, such as 1.9 lb/csf or less, such as 1.7 lb/csf or less, such as 1.5 lb/csf or less, such as 1.4 lb/csf or less, such as 1.3 lb/csf or less.

The facing material, such as the glass mat facing material, may also have a relatively open structure. For instance, the air porosity may be 50 l/m²/s or more, such as 75 l/m²/s or more, such as 100 l/m²/s or more, such as 125 l/m²/s or more, such as 150 l/m²/s or more, such as 175 l/m²/s or more, such as 200 l/m²/s or more, such as 225 l/m²/s or more, such as 250 l/m²/s or more, such as 275 l/m²/s or more, such as 300 l/m²/s or more, such as 400 l/m²/s or more, such as 500 l/m²/s or more, such as 600 l/m²/s or more, such as 700 l/m²/s or more, such as 800 l/m²/s or more, such as 900 l/m²/s or more, such as 1,000l/m²/s or more, such as 1,100l/m²/s or more, such as 1,200l/m²/s or more, such as 1,300l/m²/s or more, such as 1,400l/m²/s or more, such as 1,500l/m²/s or more. The air porosity may be 2,000 l/m²/s or less, such as 1,900l/m²/s or less, such as 1,800 l/m²/s or less, such as 1,700l/m²/s or less, such as 1,600 l/m²/s or less, such as 1,500 l/m²/s or less, such as 1,400l/m²/s or less, such as 1,300l/m²/s or less, such as 1,200l/m²/s or less, such as 1,100l/m²/s or less, such as 1,000 l/m²/s or less, such as 900 l/m²/s or less, such as 800 l/m²/s or less, such as 700 l/m²/s or less, such as 600 l/m²/s or less, such as 500 l/m²/s or less, such as 400 l/m²/s or less, such as 350 l/m²/s or less, such as 300 l/m²/s or less. The air porosity can be measured in accordance with DIN 53.887 at 100 Pa.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry.

In general, the composition of the gypsum slurry and gypsum core is not necessarily limited and may be any generally known in the art. Generally, in one embodiment, the gypsum core is made from a gypsum slurry including at least stucco and water. In this regard, the method may also include a step of combining stucco, water, and any other optional additives as mentioned herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In addition to the stucco, the gypsum slurry may also contain other hydraulic materials. These hydraulic materials may include calcium sulfate anhydrite, land plaster, cement, fly ash, or any combinations thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the hydraulic material.

As indicated above, the gypsum slurry may also include water. Water may be employed for fluidity and also for rehydration of the gypsum to allow for setting. The amount of water utilized is not necessarily limited by the present invention.

In addition, the weight ratio of the water to the stucco may be relatively high. For instance, the weight ratio of the water to the stucco may be 0.7 or more, 0.9 or more, such as 1 or more, such as 1.1 or more, such as 1.2 or more, such as 1.3 or more, such as 1.4 or more, such as 1.5 or more. The water to stucco weight ratio may be 4 or less, such as 3.5 or less, such as 3 or less, such as 2.5 or less, such as 2 or less, such as 1.9 or less, such as 1.8 or less, such as 1.7 or less, such as 1.6 or less, such as 1.5 or less, such as 1.4 or less, such as 1.3 or less, such as 1.2 or less, such as 1.1 or less, such as 1 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., BMA, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present invention.

In general, each respective additive may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more based on the weight of the stucco. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.2 wt. % or less based on the weight of the stucco. The aforementioned weight percentages may also apply based on the weight of the gypsum in the gypsum panel. In addition, the aforementioned weight percentages may also apply based on the weight of the gypsum panel. Further, the aforementioned weight percentages may also apply based on the weight of the gypsum core. Also, the aforementioned weight percentages may also apply based on the solids content of the gypsum slurry.

In general, each respective additive may be present in the gypsum slurry in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 10 lbs/MSF or more. The additive may be present in an amount of 150 lbs/MSF or less, such as 100 lbs/MSF or less, such as 50 lbs/MSF or less, such as 25 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lbs/MSF or less.

In one embodiment, the gypsum slurry may optionally include a starch in an amount of less than 4 wt. % based on the weight of stucco. For instance, the gypsum slurry may include a starch in an amount of about 0 wt. % based on the weight of stucco in the gypsum slurry. Alternatively, the gypsum slurry may include a starch in an amount of less than 4 wt. %, such as 3.8 wt. % or less, such as 3.5 wt. % or less, such as 3.3 wt. % or less, such as 3 wt. % or less, such as 2.8 wt. % or less, such as 2.5 wt. % or less, such as 2.3 wt. % or less, such as 2 wt. % or less, such as 1.8 wt. % or less, such as 1.5 wt. % or less, such as 1.3 wt. % or less, such as 1 wt. % or less, such as 0.8 wt. % or less, such as 0.6 wt. % or less, such as 0.5 wt. % or less based on the weight of stucco in the gypsum slurry. The starch may be present in an amount of greater than 0 wt. %, such as 0.1 wt. % or more, such as 0.2 wt. % or more, such as 0.5 wt. % or more, such as 0.7 wt. % or more, such as 0.9 wt. % or more, such as 1 wt. % or more, such as 1.2 wt. % or more, such as 1.4 wt. % or more, such as 1.6 wt. % or more, such as 1.8 wt. % or more, such as 2 wt. % or more, such as 2.2 wt. % or more, such as 2.4 wt. % or more, such as 2.6 wt. % or more, such as 2.8 wt. % or more based on the weight of stucco in the gypsum slurry.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In an even further embodiment, the foaming agent includes a mixture of an alkyl sulfate and an alkyl ether sulfate. In one embodiment, the foaming agent may include 100% alkyl sulfate. In another embodiment, the foaming agent may include 100% alkyl ether sulfate. When a mixture is present, the alkyl ether sulfate may be present in an amount of 50 wt. % or less, such as 40 wt. % or less, such as 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 15 wt. % or more, such as 20 wt. % or more, such as 30 wt. % or more based on the combined weight of the alkyl sulfate and the alkyl ether sulfate.

The alkyl sulfate may have a general formula as follows:

H(CH₂)ₙOSO₃⁻M⁺

wherein n is from 6 to 16 and M is a monovalent cation. In this regard, the alkyl sulfate includes alkyl chains. The alkyl may be linear, branched, or include a combination thereof. The average chain length of the alkyls may be 6 carbons or more, such as 7 carbons or more, such as 8 carbons or more, such as 9 carbons or more, such as 10 carbons or more, such as 11 carbons or more. The average chain length of the alkyls may be 15 carbons or less, such as 14 carbons or less, such as 13 carbons or less, such as 12 carbons or less, such as 11 carbons or less, such as 10 carbons or less, such as 9 carbons or less. In general, such average chain length is determined based on the length of the alkyl chains, not considering the length of any component of any alkyl ether sulfate that may be present. In addition, such average chain length is a weighted average chain length based on the amount of each specific alkyl present.

The monovalent cation may be sodium or ammonium. In one embodiment, the monovalent cation may be ammonium. In another embodiment, the monovalent cation may be sodium.

The alkyl ether sulfate may have a general formula as follows:

CH₃(CH₂)ₓCH₂—(OCH₂CH₂)_{y}—OSO₃⁻M⁺

wherein x is from 4 to 13, y is from 0.05 to 5, and M is a monovalent cation.

The alkyl portion of the alkyl ether sulfate may be 6 carbons or more, such as 7 carbons or more, such as 8 carbons or more, such as 9 carbons or more, such as 10 carbons or more, such as 11 carbons or more. Accordingly, x may be 4 or more, such as 5 or more, such as 6 or more, such as 7 or more, such as 8 or more, such as 9 or more, such as 10 or more. The alkyl portion of the alkyl ether sulfate may be 15 carbons or less, such as 14 carbons or less, such as 13 carbons or less, such as 12 carbons or less, such as 11 carbons or less, such as 10 carbons or less, such as 9 carbons or less. Accordingly, x may be 13 or less, such as 11 or less, such as 10 or less, such as 9 or less, such as 8 or less.

The ethoxylated content (y) of the alkyl ether sulfate may be 0.05 or more, such as 0.1 or more, such as 0.2 or more, such as 0.3 or more, such as 0.5 or more, such as 1 or more, such as 1.2 or more, such as 1.5 or more, such as 1.8 or more, such as 2 or more, such as 2.2 or more, such as 2.5 or more, such as 3 or more. The ethoxylated content of the alkyl ether sulfate may be 5 or less, such as 4.8 or less, such as 4.5 or less, such as 4.3 or less, such as 4 or less, such as 3.7 or less, such as 3.5 or less, such as 3.2 or less, such as 3 or less, such as 2.8 or less, such as 2.5 or less, such as 2.3 or less, such as 2 or less, such as 1.7 or less, such as 1.5 or less, such as 1.3 or less, such as 1 or less, such as 0.9 or less, such as 0.7 or less.

The monovalent cation may be sodium or ammonium. In one embodiment, the monovalent cation may be ammonium. In another embodiment, the monovalent cation may be sodium.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

By utilizing a soap or foaming agent as disclosed herein, the gypsum slurry may include bubbles or voids due to the soap/foaming agent having a particular size. Such size may then contribute to the void structure in the gypsum panel and the resulting lightweight and/or low density properties. In this regard, the gypsum slurry may have bubbles or voids having a median size of 50 microns or more, such as 100 microns or more, such as 150 microns or more, such as 200 microns or more, such as 250 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 350 microns or less, such as 300 microns or les, such as 250 microns or less, such as 200 microns or less, such as 150 microns or less, such as 100 microns or less. Furthermore, while the aforementioned references a median size, it should be understood that in another embodiment, such size may also refer to an average size.

The foam and/or foaming agent may be provided in an amount of 0.005 lbs/ft³ or more, such as 0.01 lbs/ft³ or more, such as 0.1 lbs/ft³ or more, such as 0.5 lbs/ft³ or more, such as 1 lbs/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foam and/or foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less, such as 5 lbs/ft³ or less, such as 4 lbs/ft³ or less, such as 3 lbs/ft³ or less, such as 2 lbs/ft³ or less, such as 1 lbs/ft³ or less, such as 0.5 lbs/ft³ or less, such as 0.3 lbs/ft³ or less, such as 0.2 lbs/ft³ or less, such as 0.1 lbs/ft³ or less, such as 0.05 lbs/ft³ or less.

The foam and/or foaming agent may be provided in an amount of 0.005 lbs/MSF or more, such as 0.01 lbs/MSF or more, such as 0.1 lbs/MSF or more, such as 0.2 lbs/MSF or more, such as 0.3 lbs/MSF or more, such as 0.4 lbs/MSF or more, such as 0.5 lbs/MSF or more, such as 0.7 lbs/MSF or more, such as 0.9 lbs/MSF or more, such as 1 lbs/MSF or more, such as 1.1 lbs/MSF or more, such as 1.3 lbs/MSF or more, such as 1.5 lbs/MSF or more, such as 1.8 lbs/MSF or more. The foam and/or foaming agent may be provided in an amount of 5 lbs/MSF or less, such as 4 lbs/MSF or less, such as 3 lbs/MSF or less, such as 2.5 lbs/MSF or less, such as 2.2 lbs/MSF or less, such as 2 lbs/MSF or less, such as 1.8 lbs/MSF or less, such as 1.6 lbs/MSF or less, such as 1.4 lbs/MSF or less, such as 1.2 lbs/MSF or less, such as 1 lbs/MSF or less, such as 0.8 lbs/MSF or less, such as 0.6 lbs/MSF or less, such as 0.5 lbs/MSF or less, such as 0.4 lbs/MSF or less, such as 0.3 lbs/MSF or less, such as 0.2 lbs/MSF or less, such as 0.1 lbs/MSF or less, such as 0.05 lbs/MSF or less.

The manner in which the components for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for dewatering of the gypsum slurry, in particular dewatering any free water instead of combined water of the gypsum slurry. Such dewatering may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal of any free water. The temperature and time required for drying in such heating device are not necessarily limited by the present invention.

In one embodiment, the gypsum core may include a first gypsum core layer and a second gypsum core layer. The first gypsum core layer may be between the first facing material (i.e., front of the panel) and the second gypsum core layer. In addition, the first gypsum core layer may have a density greater than the second gypsum core layer. Accordingly, the first gypsum core layer may be formed using a gypsum slurry without the use of a foaming agent or with a reduced amount of foaming agent, which may be utilized in forming the second gypsum core layer. In this regard, in one embodiment, the first gypsum core layer may have the same composition as the second gypsum core layer except that the second gypsum core layer may be formed using a foaming agent or a greater amount of foaming agent.

In one embodiment, the gypsum core may also include a third gypsum core layer. The third gypsum core layer may be provided between the second gypsum core layer and a second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent or with a reduced amount of foaming agent, which may be utilized in forming the second gypsum core layer. In this regard, in one embodiment, the third gypsum core layer may have the same composition as the second gypsum core layer except that the second gypsum core layer may be formed using a foaming agent or a greater amount of foaming agent.

In this regard, when the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent or more foaming agent than the first gypsum slurry. In this regard, in one embodiment, the first gypsum slurry may not include a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent or more foaming agent than the third gypsum slurry. In this regard, in one embodiment, the third gypsum slurry may not include a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

In addition, the first gypsum core layer and/or the third gypsum core layer may also have the additives as mentioned above. In addition, such layers may also include other additives. These may include glass fillers, fibers, whiskers, crystal modifiers, polymeric materials, etc. The fibers may include inorganic fibers. The polymeric materials may be organic or inorganic polymeric materials.

The glass fillers may include any variety of fillers. For instance, these may include hollow glass spheres, glass beads, glass fibers, foamed glass, or a mixture thereof. The glass fibers may include short glass fibers, long glass fibers, or a mixture thereof. In one embodiment, the filler may include glass fibers. In another embodiment, the filler may include glass beads.

The crystal modifiers may include a calcium salt, potash, and/or chelating agents. For example, these salts may include, but are not limited to, calcium chloride, calcium nitrate, calcium acetate, calcium carbonate, calcium bicarbonate, calcium hydroxide, calcium nitrate, calcium iodide, calcium fluoride, calcium phosphate, calcium citrate, calcium lactate, calcium gluconate, etc. as well as mixtures thereof. The chelating agents may include, but are not limited to, phosphates (e.g., tripolyphosphates), phosphonic acids (e.g., hydroxyethylenediphophonic acid), polyamines (e.g., ethylenediamine and salts thereof), aminocarboxylic acids (e.g., ethylenediaminetetraacetic acid), diketones (e.g., acetylacetone), hydroxycarboxylic acids (e.g., tartaric acid, citric acid), aminoalcohols (e.g., triethanolamine), sulfur compounds (e.g., thiourea), etc. as well as mixtures thereof.

Further strength and performance improvements could be made by concentrating the performance-adding materials (e.g., strength, acoustical, fire resistance-enhancing, etc.) in a dense layer, at the facer to core interface, or via facer coatings to reduce the overall material used in the gypsum panel and thereby maintain a low weight and/or a low density while improving properties.

Yet more applications can be envisaged through the addition of other additives such sound-dampening polymers, water resistance additives, mold and mildew resistance additives, fire-resistant additives, performance foams, tailored enhanced coatings (e.g., water-resistance, vapor barrier, strength-enhancing, fire resistance, etc.), etc.

The gypsum panel disclosed herein may have many applications. For instance, the gypsum panel may be used as a standalone panel in construction for the preparation of walls, ceilings, floors, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 550 lbs/MSF or more, such as about 600 lbs/MSF or more, such as about 650 lbs/MSF or more, such as about 700 lbs/MSF or more, such as about 800 lbs/MSF or more, such as about 900 lbs/MSF or more, such as about 1,000 lbs/MSF or more, such as about 1,100 lbs/MSF or more, such as about 1,300 lbs/MSF or more, such as about 1,400 lbs/MSF or more, such as about 1,500 lbs/MSF or more. The panel weight may be about 1,800 lbs/MSF or less, such as about 1,700 lbs/MSF or less, such as about 1,600 lbs/MSF or less, such as about 1,500 lbs/MSF or less, such as about 1,400 lbs/MSF or less, such as about 1,300 lbs/MSF or less, such as about 1,200 lbs/MSF or less, such as about 1,100 lbs/MSF or less, such as about 1,000 lbs/MSF or less, such as about 900 lbs/MSF or less, such as about 850 lbs/MSF or less, such as about 800 lbs/MSF or less, such as about 750 lbs/MSF or less, such as about 700 lbs/MSF or less. Such panel weight may be a dry panel weight such as after the panel leaves the heating or drying device (e.g., kiln).

In addition, the gypsum panel may have a density of about 5 pcf or more, such as about 6 pcf or more, such as about 7 pcf or more, such as about 8 pcf or more, such as about 9 pcf or more, such as about 10 pcf or more, such as about 11 pcf or more, such as about 12 pcf or more, such as about 13 pcf or more, such as about 14 pcf or more, such as about 15 pcf or more, such as about 15 pcf or more, such as about 18 pcf or more, such as about 20 pcf or more, such as about 22 pcf or more, such as about 24 pcf or more, such as about 26 pcf or more, such as about 28 pcf or more. The panel may have a density of about 33 pcf or less, such as about 31 pcf or less, such as about 30 pcf or less, such as about 29 pcf or less, such as about 27 pcf or less, such as about 25 pcf or less, such as about 23 pcf or less, such as about 21 pcf or less, such as about 20 pcf or less, such as about 19 pcf or less, such as about 18 pcf or less, such as about 17 pcf or less, such as about 16.5 pcf or less, such as about 16 pcf or less, such as about 15 pcf or less, such as about 14 pcf or less, such as about 13 pcf or less, such as about 12 pcf or less, such as about 11 pcf or less, such as about 10 pcf or less, such as about 9 pcf or less, such as about 8 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about lb_{f}, such as at least about 100 lb_{f} as tested according to ASTM C₁₃₉₆. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about lb_{f} or less, such as about 90 lb_{f} or less, such as about 85 lb_{f} or less, such as about 80 lb_{f} or less as tested according to ASTM C₁₃₉₆. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C₄₇₃. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C₁₃₉₆. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C₁₃₉₆. In addition, the gypsum panel may have an end hardness according to the aforementioned values. Further, the gypsum panel may have an edge hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

Also, the gypsum panel may have a certain flexural strength also referred to as the peak load at failure. For instance, the flexural strength may be about 5 lb_{f} or more, such as 6 lb_{f} or more, such as 8 lb_{f} or more, such as 10 lb_{f} or more, such as 12 lb_{f} or more, such as 14 lb_{f} or more, such as 16 lb_{f} or more, such as 18 lb_{f} or more, such as 20 lb_{f} or more, such as 22 lb_{f} or more, such as 24 lb_{f} or more, such as 26 lb_{f} or more, such as 28 lb_{f} or more, such as 30 lb_{f} or more, such as 32 lb_{f} or more, such as 34 lb_{f} or more, such as 36 lb_{f} or more. The flexural strength may be about 50 lb_{f} or less, such as about 45 lb_{f} or less, such as about 40 lb_{f} or less, such as about 36 lb_{f} or less, such as about 34 lb_{f} or less, such as about 32 lb_{f} or less, such as about 30 lb_{f} or less, such as about 28 lb_{f} or less, such as about 26 lb_{f} or less, such as about 24 lb_{f} or less, such as about 22 lb_{f} or less, such as about 20 lb_{f} or less, such as about 18 lb_{f} or less, such as about 16 lb_{f} or less, such as about 14 lb_{f} or less, such as about 12 lb_{f} or less, such as about 10 lb_{f} or less. The flexural strength may be determined according to ASTM C473-19 as modified below. Such flexural strength may be based upon the thickness of the gypsum panel. For instance, when conducting a test, such flexural strength values may vary depending on the thickness of the gypsum panel. As an example, the flexural strength values above may be for a ⅝ inch panel. However, it should be understood that instead of a ⅝ inch panel, such flexural strength values may be for any other thickness gypsum panel as mentioned herein.

### EXAMPLES

NRC values: For evaluating NRC values, an impedance tube was utilized to generate data across the full Hertz spectrum and specifically at Hertz frequencies that make up the NRC value (i.e., 250 Hz, 500 Hz, 1000 Hz, and 2000 Hz). In particular, the data was generated based on ASTM E1050 using multiple impedance tube sizes/diameters.

Flexural Strength: The flexural strength was measured in accordance with ASTM C473-19 with modifications. In particular, the flexural strength was tested with a support span of 8″, an X-head rate of 0.1″/min, and a sample size of 10″ length and 4″ width. Boards were conditioned at 70° F. and 50% relative humidity for 24 hours before testing. The maximum/peak value was recorded as the “flexural strength” value.

### Example 1

Gypsum panel samples were manufactured at various weights and densities. The gypsum panels were prepared using 700 lbs/MSF stucco and a water/stucco ratio of 1.1. The samples also utilized an alkyl sulfate foaming agent, a starch (2.5 lbs/MSF), BMA (3.6 lbs/MSF), STMP (1 lbs/MSF), cellulose fibers (7 lbs/MSF), a dispersant (3 lbs/MSF), glass fibers (3 lbs/MSF), and boric acid (1.1 lbs/MSF). The panels had a thickness of ⅝″.

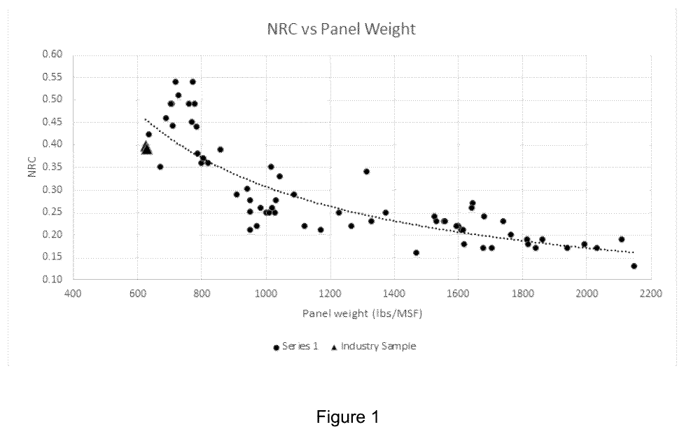

The NRC values were determined for the samples. Such NRC values are illustrated in FIG. 1. The data of certain gypsum panels below is also based on the gypsum panels presented in FIGS. 2 and 3. As can be seen, gypsum panels having a relatively low weight and/or low density unexpectedly exhibited a relatively higher NRC value.

| | Thickness | Weight | Density | NRC |
|---|---|---|---|---|
| Panel | (inches) | (lbs/MSF) | (pcf) | Value |
| Conventional (mineral | ⅝ | 560 | 10.8 | 0.44 |
| fiber-based panel) | | | | |
| Gypsum panel 1 | ⅝ | 752 | 14.4 | 0.52 |
| Gypsum panel 2 | ⅝ | 746 | 14.3 | 0.49 |
| Gypsum panel 3 | ⅝ | 1370 | 26.3 | 0.43 |
| Gypsum panel 4 | ⅝ | 1070 | 20.5 | 0.47 |
| Gypsum panel 5 | ⅝ | 1270 | 24.3 | 0.45 |
| Gypsum panel 6 | ⅝ | 1320 | 25.3 | 0.48 |
| Gypsum panel 7 | ⅝ | 1320 | 25.3 | 0.44 |
| Gypsum panel 8 | ⅝ | 1620 | 31.1 | 0.36 |

### Example 2

Gypsum panel samples were manufactured at various weights and densities. The gypsum panels were prepared and optionally contained fibers, such as glass fibers and/or cellulose fibers. The flexural strength, also referred to as the peak load at failure, of these panels was compared against a commercially available gypsum panel. As indicated below, the panels made according to the present disclosure exhibited improved flexural strength.

| | Panel | Glass | Cellulose | Flexural |
|---|---|---|---|---|
| | Weight | Fibers | Fibers | Strength |
| Panel | (lbs/MSF) | (g) | (g) | (lbf) |
| Commercial Sample | 610 | <13 wt. % | — | 8.20 |
| Gypsum panel 9 | 935 | 0 | 0 | 24.95 |
| Gypsum panel 10 | 922 | 3 | 0 | 29.04 |
| Gypsum panel 11 | 746 | 3 | 0 | 17.03 |
| Gypsum panel 12 | 852 | 3 | 7 | 26.44 |

### Example 3

Gypsum panel samples were manufactured having a thickness of ⅝″. The inventive gypsum panel was prepared and included glass beads within a dense layer of the gypsum core. The control sample did not include glass beads while Gypsum panel 13 included 4 lbs (approx. 0.4% by weight based on the weight of stucco) of glass beads. The gypsum panels also included paper facing materials. The impact of the glass beads on the NRC value was determined.

| | Panel Weight | Density | NRC |
|---|---|---|---|
| Panel | (lbs/MSF) | (pcf) | Value |
| Control Sample | 1369 | 26.3 | 0.10 |
| Gypsum panel 13 | 1375 | 26.4 | 0.20 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1-30. (canceled)

31. A gypsum panel comprising a gypsum core and a facing material,
the gypsum core comprising gypsum, a foaming agent, and optionally starch in an amount of less than 4 wt. % based on the weight of gypsum,
wherein the gypsum core includes air voids having an average void size of microns or more,
wherein the gypsum panel has a density of 33 pcf or less, a weight of 1,800 lbs/MSF or less, and an NRC value of 0.2 or more.

32. The gypsum panel of claim 31, wherein the foaming agent includes an alkyl sulfate foaming agent.

33. The gypsum panel of claim 31, wherein the gypsum panel has a density of 25 pcf or less.

34. The gypsum panel of claim 31, wherein the gypsum panel has a density of 16.5 pcf or less.

35. The gypsum panel of claim 31, wherein the gypsum panel has a weight of 1,500 lbs/MSF or less.

36. The gypsum panel of claim 31, wherein the gypsum panel has a weight of 1,000 lbs/MSF or less.

37. The gypsum panel of claim 31, wherein the gypsum panel has a thickness of about ⅝″.

38. The gypsum panel of claim 31, wherein the gypsum panel has an interconnected core structure.

39. The gypsum panel of claim 31, wherein the facing material comprises a paper facing material.

40. The gypsum panel of claim 31, wherein the facing material comprises a glass mat facing material.

41. The gypsum panel of claim 40, wherein the glass mat facing material comprises glass fibers having an average diameter of from 3 microns to 23 microns.

42. The gypsum panel of claim 31, wherein the facing material has an air porosity of from 50 l/m²/s to 2,000 l/m²/s.

43. The gypsum panel of claim 31, wherein the gypsum panel has a flexural strength of from 10 lb_{f} to 50 lb_{f}.

44. The gypsum panel of claim 31, wherein the gypsum panel has a flexural strength of from 20 lb_{f} to 30 lb_{f}.

45. The gypsum panel of claim 31, wherein the air voids have an average air void size of 200 microns or more.

46. The gypsum panel of claim 31, wherein the air voids have an average air void size of 300 microns or more.

47. The gypsum panel of claim 31, wherein the gypsum core comprises a starch in an amount of greater than 0 wt. % to less than 4 wt. % based on the weight of gypsum.

48. The gypsum panel of claim 31, wherein the gypsum core further comprises a glass filler.

49. The gypsum panel of claim 31, wherein the gypsum core includes a first gypsum core layer and a second gypsum core layer, the first gypsum core layer having a density greater than the second gypsum core layer and a thickness lass then the second gypsum core layer.

50. The gypsum panel of claim 49, wherein the first gypsum core layer comprises a glass filler.

51. A method of making a gypsum panel, the method comprising:
providing a first facing material,
providing a gypsum slurry comprising stucco, a foaming agent, optionally starch in an amount of less than 4 wt. % based on the weight of stucco, and water onto the first facing material,
providing a second facing material onto the gypsum slurry, and
allowing the stucco to set;
wherein the gypsum panel has a density of 33 pcf or less, a weight of 1,800 lbs/MSF or less, and an NRC value of 0.2 or more.

52. A gypsum panel comprising a gypsum core and a facing material,
the gypsum core comprising gypsum, a foaming agent, and optionally starch in an amount of less than 4 wt. % based on the weight of gypsum,
wherein the gypsum panel has a density of 33 pcf or less, a weight of 1,800 lbs/MSF or less, and an NRC value of 0.2 or more.
